(19) United States
(12) Patent Application Publication
(10) Pub. No.: US 2006/0161647 A1
(43) Pub. Date: Jul. 20, 2006

(54) Method and apparatus providing measurement of packet latency in a processor

(76) Inventors: Waldemar Wojtkiewicz, Banino (PL); Jacek Szyszko, Gdynia (PL)

Correspondence Address: DALY, CROWLEY & MOFFORD, LLP, C/O PORTFOLIOIP, P. O. BOX 52050, MINNEAPOLIS, MN, 55402, US

(21) Appl. No.: 11/020,788

(22) Filed: Dec. 22, 2004

(51) Int. Cl. G06F 15/173

(52) U.S. Cl. 709/224

(57) ABSTRACT

A latency measurement unit, which can form part of a processor unit having multiple processing elements, includes a content addressable memory to store packet ID information and time information for a packet associated with at least one selected source and at least one selected destination.

### CROSS REFERENCE TO RELATED APPLICATIONS

Not Applicable.

### STATEMENT REGARDING FEDERALLY SPONSORED RESEARCH

Not Applicable.

### BACKGROUND

As known in the art, processors, such as multi-core, single die, network processor units (NPUs), can receive data, e.g., packets, from a source and transmit processed data, to a destination at various line rates. The performance of such NPUs can be measured by the number of packets processed per time unit, e.g., one second. However, for NPUs having multiple processing elements, such a performance metric may provide information on how long a single packet has been processed by the NPU.

In general, the NPU data path structure and multiple processing elements enable parallel processing of a number of packets. However, without knowledge of the latency of packets, it may be difficult to evaluate the overall performance of NPU applications. In addition, even knowing how long the packets are processed by the NPU, the performance of the various processing elements may not be known. For example, a user or programmer may not be able to ascertain that a particular processing element presents a bottleneck in the overall data processing scheme.

### BRIEF DESCRIPTION OF THE DRAWINGS

The exemplary embodiments contained herein will be more fully understood from the following detailed description taken in conjunction with the accompanying drawings, in which:

FIG. 1 is a diagram of an exemplary system including a network device having a network processor unit with a mechanism to avoid memory back conflicts when accessing queue descriptors;

FIG. 2 is a diagram of an exemplary network processor having processing elements with a conflict-avoiding queue descriptor structure;

FIG. 3 is a diagram of an exemplary processing element (PE) that runs microcode;

FIG. 4 is a diagram showing an exemplary queuing arrangement;

FIG. 5 is a diagram showing queue control structures;

FIG. 6 is a pictorial representation of packets being processed by a network processing unit;

FIG. 7 is a schematic depiction of data being processed by multiple processing elements;

FIG. 8A is a schematic representation of a memory having scratch rings;

FIG. 8B is a schematic representation of a scratch ring having inert and remove pointers;

FIG. 9 is a schematic representation of a portion of a processor having a latency measurement unit;

FIG. 10 is a schematic representation of a content addressable memory that can form a part of a latency measurement unit.

FIG. 11 is a schematic representation of latency measurement mechanism;

FIG. 11A is a schematic representation of a latency measurement unit;

FIG. 12A is a flow diagram of read/get latency measurement processing; and

FIG. 12B is a flow diagram of write/put latency measurement processing.

### DETAILED DESCRIPTION

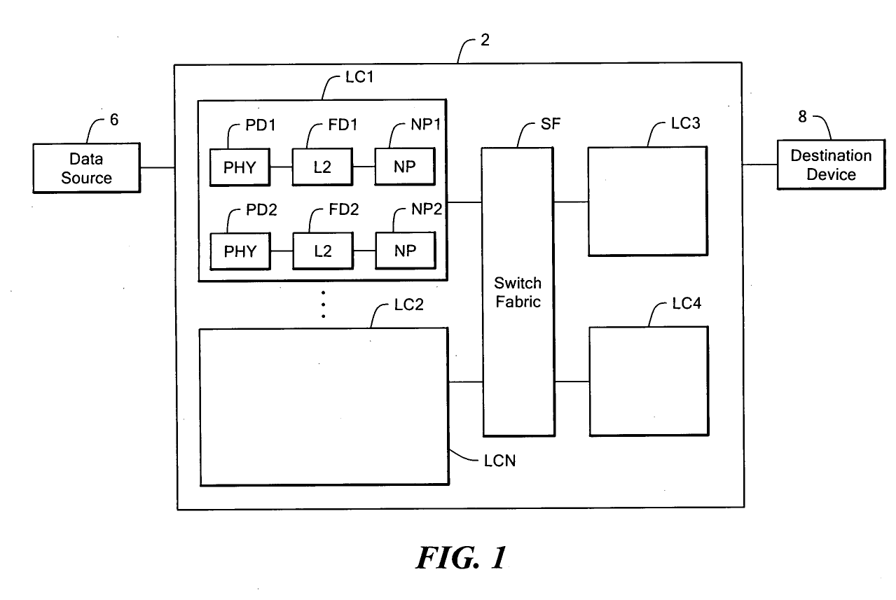

FIG. 1 shows an exemplary network device 2 including network processor units (NPUs) having the capability to measure data propagation latency. The NPUs can process incoming packets from a data source 6 and transmit the processed data to a destination device 8. The network device 2 can include, for example, a router, a switch, and the like. The data source 6 and destination device 8 can include various network devices now known, or yet to be developed, that can be connected over a communication path, such as an optical path having a OC-192 (10 Gbps) line speed.

The illustrated network device 2 can measure packet latency as described in detail below. The device 2 features a collection of line cards LC1-LC4 (“blades”) interconnected by a switch fabric SF (e.g., a crossbar or shared memory switch fabric). The switch fabric SF, for example, may conform to CSIX (Common Switch Interface) or other fabric technologies such as HyperTransport, Infiniband, PCI (Peripheral Component Interconnect), Packet-Over-SONET, RapidIO, and/or UTOPIA (Universal Test and Operations PHY Interface for ATM(Asynchronous Transfer Mode)).

Individual line cards (e.g., LC1) may include one or more physical layer (PHY) devices PD1, PD2 (e.g., optic, wire, and wireless PHYs) that handle communication over network connections. The PHYs PD translate between the physical signals carried by different network mediums and the bits (e.g., “0”-s and “1”-s) used by digital systems. The line cards LC may also include framer devices (e.g., Ethernet, Synchronous Optic Network (SONET), High-Level Data Link (HDLC) framers or other “layer 2” devices) FD1, FD2 that can perform operations on frames such as error detection and/or correction. The line cards LC shown may also include one or more network processors NP1, NP2 that perform packet processing operations for packets received via the PHY(s) and direct the packets, via the switch fabric SF, to a line card LC providing an egress interface to forward the packet. Potentially, the network processor(s) NP may perform “layer 2” duties instead of the framer devices FD.

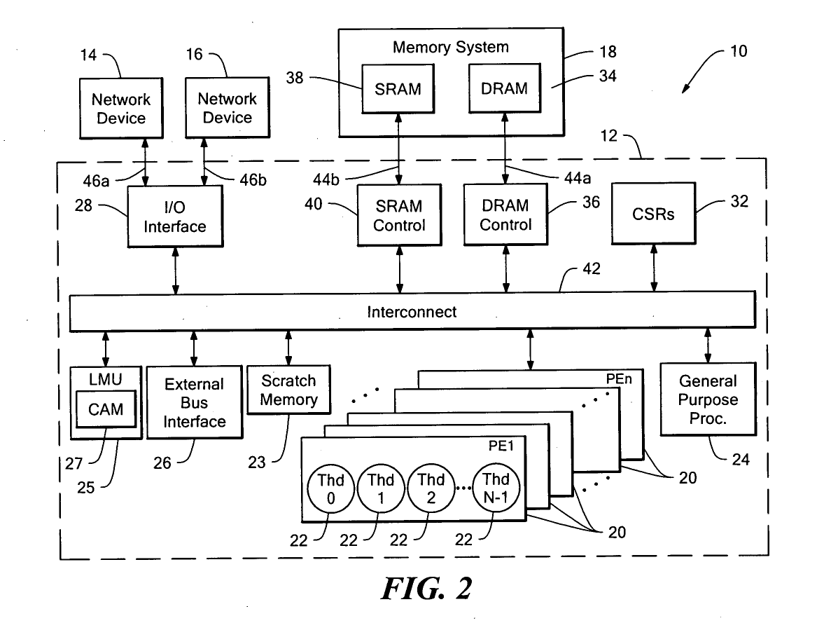

FIG. 2 shows an exemplary system 10 including a processor 12, which can be provided as a multi-core, single-die network processor. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22. In the described embodiment, the maximum number “N” of threads supported by the hardware is eight. Each of the processing elements 20 is connected to and can communicate with other processing elements. Scratch memory 23 can facilitate data transfers between processing elements as described more fully below. In one embodiment, the scratch memory 23 is 16 kB.

The processor 12 further includes a latency measurement unit (LMU) 25, which can include a content addressable memory (CAM) 27, to measure the latency for data from the time it is received from the network interface 28, processed by the one or more PEs 22, and transmitted to the network interface 28, as described more fully below.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, and so forth.

The devices 14, 16 can be any network devices capable of transmitting and/or receiving network traffic data, such as framing/MAC (Media Access Control) devices, e.g., for connecting to 10/100BaseT Ethernet, Gigabit Ethernet, ATM (Asynchronous Transfer Mode) or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also be serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

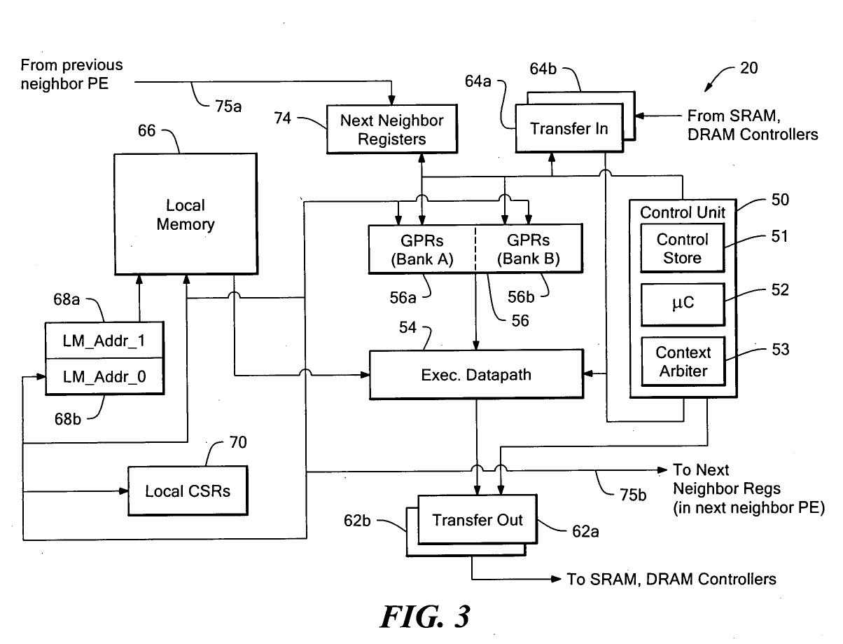

Referring to FIG. 3, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes a write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_1”), 68b (“LM_Addr_0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

While illustrative target hardware is shown and described herein in some detail, it is understood that the exemplary embodiments shown and described herein for data latency measurement are applicable to a variety of hardware, processors, architectures, devices, development systems/tools and the like.

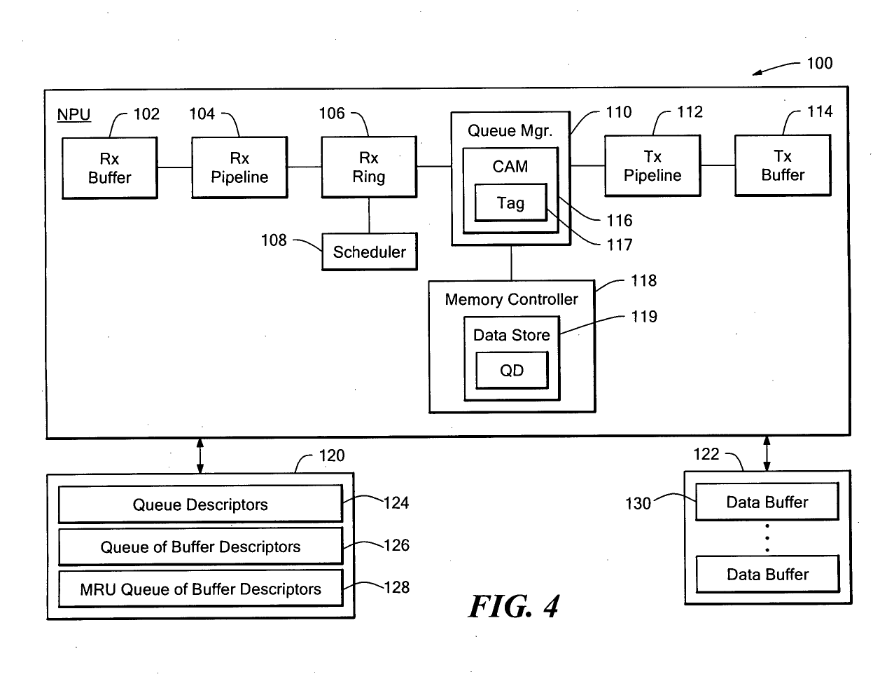

FIG. 4 shows an exemplary NPU 100 receiving incoming data and transmitting the processed data using queue data control structures. As described in detail below, the latency of the data from source to destination can be measured. Processing elements in the NPU 100 can perform various functions. In the illustrated embodiment, the NPU 100 includes a receive buffer 102 providing data to a receive pipeline 104 that sends data to a receive ring 106, which may have a first-in-first-out (FIFO) data structure, under the control of a scheduler 108. A queue manager 110 receives data from the ring 106 and ultimately provides queued data to a transmit pipeline 112 and transmit buffer 114. A content addressable memory (CAM) 116 includes a tag area to maintain a list 117 of tags each of which points to a corresponding entry in a data store portion 119 of a memory controller 118. In one embodiment, each processing element includes a CAM to cache a predetermined number, e.g., sixteen, of the most recently used (MRU) queue descriptors. The memory controller 118 communicates with the first and second memories 120, 122 to process queue commands and exchange data with the queue manager 110. The data store portion 119 contains cached queue descriptors, to which the CAM tags 117 point.

The first memory 120 can store queue descriptors 124, a queue of buffer descriptors 126, and a list of MRU (Most Recently Used) queue of buffer descriptors 128 and the second memory 122 can store processed data in data buffers 130, as described more fully below.

While first and second memories 102, 122 are shown, it is understood that a single memory can be used to perform the functions of the first and second memories. In addition, while the first and second memories are shown being external to the NPU, in other embodiments the first memory and/or the second memory can be internal to the NPU.

The receive buffer 102 buffers data packets each of which can contain payload data and overhead data, which can include the network address of the data source and the network address of the data destination. The receive pipeline 104 processes the data packets from the receive buffer 102 and stores the data packets in data buffers 130 in the second memory 122. The receive pipeline 104 sends requests to the queue manager 110 through the receive ring 106 to append a buffer to the end of a queue after processing the packets. Exemplary processing includes receiving, classifying, and storing packets on an output queue based on the classification.

An enqueue request represents a request to add a buffer descriptor that describes a newly received buffer to the queue of buffer descriptors 126 in the first memory 120. The receive pipeline 104 can buffer several packets before generating an enqueue request.

The scheduler 108 generates dequeue requests when, for example, the number of buffers in a particular queue of buffers reaches a predetermined level. A dequeue request represents a request to remove the first buffer descriptor. The scheduler 108 also may include scheduling algorithms for generating dequeue requests such as “round robin”, priority-based, or other scheduling algorithms. The queue manager 110, which can be implemented in one or more processing elements, processes enqueue requests from the receive pipeline 104 and dequeue requests from the scheduler 108.

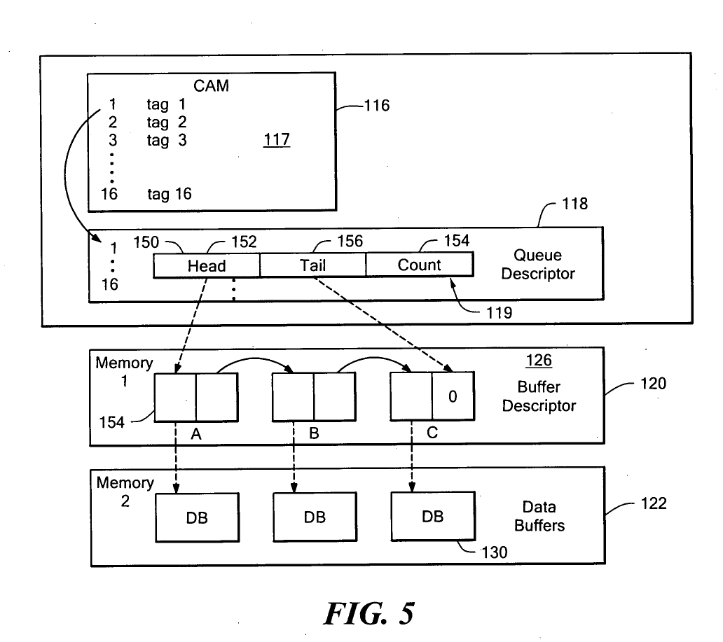

FIG. 5, in combination with FIG. 4, shows exemplary data structures that describe the queues using queue descriptors managed by a queue manager. In one embodiment, the memory controller 118 includes a cached queue descriptor 150 having a head pointer 152 that points to the first entry 154 of a queue A, a tail pointer 156 that points to the last entry C of a queue, and a count field 154 which indicates the number of entries currently on the queue.

The tags 117 are managed by the CAM 116, which can include a least recently used (LRU) cache entry replacement policy. The tags 117 reference a corresponding one of the last N queue descriptors in the memory controller 118 used to perform an enqueue or dequeue operation, where N is the number of entries in the CAM. The queue descriptor location in memory is stored as a CAM entry. The actual data placed on the queue is stored in the second memory 122 in the data buffers 130 and is referenced by the queues of buffer descriptors 126 located in the first memory 120.

For single-buffer packets, an enqueue request references a tail pointer 156 and a dequeue request references a head pointer 152. The memory controller 118 maintains a predetermined number, e.g., sixteen, of the most recently used (MRU) queue descriptors 150. Each cached queue descriptor includes pointers to the corresponding MRU queue of buffer descriptors 128 in the first memory 120.

There is a mapping between the memory address of each buffer descriptor 126 (e.g., A, B, C) and the memory address of the buffer 130. The buffer descriptor can include an address field (pointing to a data buffer), a cell count field, and an end of packet (EOP) bit. Because each data buffer may be further divided into cells, the cell count field includes information about a cell count of the buffer. In one embodiment, the first buffer descriptor added to a queue will be the first buffer descriptor removed from the queue. For example, each buffer descriptor A, B in a queue, except the last buffer descriptor in the queue, includes a buffer descriptor pointer to the next buffer descriptor in the queue in a linked list arrangement. The buffer descriptor pointer of the last buffer descriptor C in the queue can be null.

The uncached queue descriptors 124 in the first memory 120 are not referenced by the memory controller. Each uncached queue descriptor 124 can be assigned a unique identifier and can include pointers to a corresponding uncached queue of buffer descriptors 126. And each uncached queue of buffer descriptors 126 can includes pointers to the corresponding data buffers 130 in the second memory 122.

Each enqueue request can include an address of the data buffer 130 associated with the corresponding data packet. In addition, each enqueue or dequeue request can include an identifier specifying either an uncached queue descriptor 124 or a MRU queue descriptor in the memory controller 118 associated with the data buffer 130.

In one aspect of exemplary embodiments shown and described herein, a network processing unit includes a latency measurement unit to measure data latency from a source to a destination. The network processing unit can include processing elements each of which can contribute to data latency. The latency measurement unit can facilitate the identification of processing bottlenecks, such as particular processing elements, that can be addressed to enhance overall processing performance. For example, a first processing element may require relatively little processing time and a second processing element may require significantly more processing time. A scratch ring to facilitate the transfer of data from the first processing element to the second processing element may be overwhelmed when bursts of packets are experienced. After identifying such a situation by measuring data latency, action can be taken to address the potential problem. For example, functionality can be moved to the second processing element from the first processing element, and/or the scratch ring capacity can be increased. However, these solutions depend upon identifying the potential data latency issue.

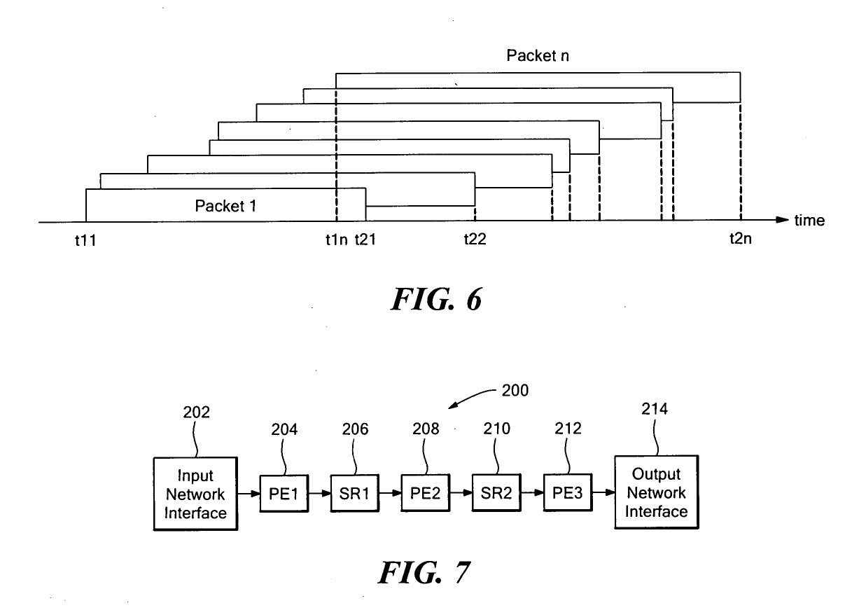

FIG. 6 shows n packets being processed in parallel by a network processing unit (NPU). Packet processing times can be characterized as t<x,y>, where the time of data reception is indicated as x=1, the time of data transmission is indicated as x=2, and the packet number is indicated as y. For example, the first packet is received at time t11 and transmitted at time t21.

It is straightforward to measure a number of packets an NPU can process, e.g., receive and transmit, in a unit of time. It is also relatively easy to determine the delay between data reception and transmission for the data packets. However, this information may not be sufficient for NPU microcode developers to avoid and/or identify bottlenecks in one or more processing elements within the NPU.

FIG. 7 shows an exemplary data flow 200 as data is received via an input network interface 202, such as a receive buffer, and sent to a first processing element 204 for processing. After processing, data is sent via a first scratch ring 206 to a second processing element 208 for further processing. The processed data is sent via a second scratch ring 210 to a third processing element 212 and then to an output network interface 214, such as a transmit buffer. Table 1 below sets forth the source and destination relationships.

TABLE 1
Source and Destination

| Processing | | |
|---|---|---|
| Element | Data source | Data destination |
| PE1 | Input NI | SR1 |
| PE2 | SR1 | SR2 |
| PE3 | SR2 | output NI |

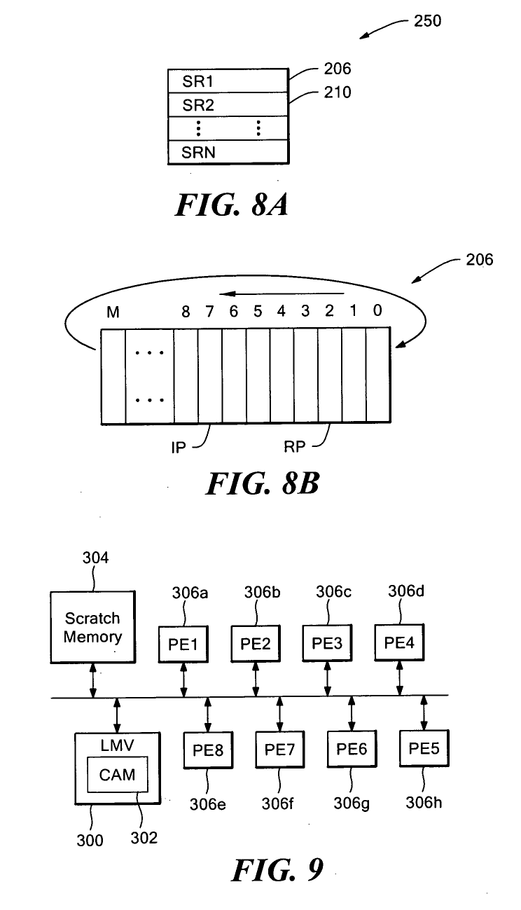

As shown in FIG. 8A, an area of memory 250 can be used for the various scratch rings 206, 210. As shown in FIG. 8B, the scratch ring, such as the first scratch ring 206 can be provided using an insert pointer IP and a remove pointer RP. The insert pointer IP points to the next location in which data will be written to the scratch ring and the remove pointer points to the location from which data will be extracted. The scratch rings can contain pointers to packet descriptors, which are described above. In general, the scratch rings 206, 210 can be considered circular buffers to facilitate rapid data exchange between processing elements.

It will be readily apparent to one of ordinary skill in the art that various memory structures can be used to provide scratch ring functionality without departing from the exemplary embodiments shown and described herein.

In general, the NPU utilizes elapsed time, as measured in clock cycles, to measure latency when reading data from a source, e.g., network interface or scratch ring, and writing data to a destination, e.g., scratch ring or network interface. The data path latency can be measured by adding the processing path times. The latency of a particular processing element can also be determined based upon sequential elapsed times.

It should be noted that both the source and destination can point to the same scratch ring. In this case, one can measure an average time the data stays in the scratch ring. For example, a scratch ring PUT operation triggers a snapshot in time and a CAM entry write.

In one embodiment, latency measurements can be turned on and off at any time without preparing any special code for this purpose. Dynamic reconfiguration of this feature facilitates performing processor application diagnostics in an operational environment without any disruption of the working devices.

FIG. 9 shows an exemplary latency measurement unit (LMU) 300 having a CAM 302 to hold packet latency information. The scratch memory 304, processing elements 306a-h, and LMU 300 communicate over a bus 306. The CAM 302 stores packet identification information and packet time information.

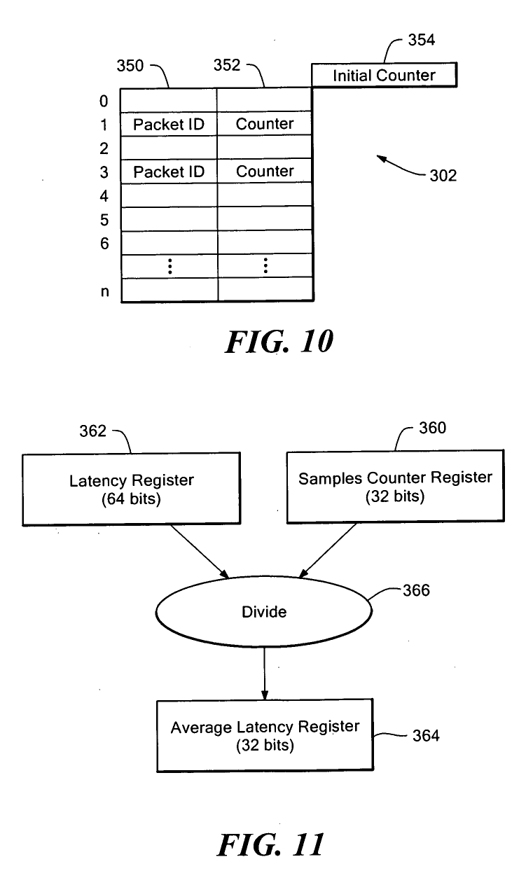

FIG. 10 shows an exemplary structure for the CAM 302 including a first field 350 for a packet identifier to uniquely identify each packet and a second field 352 for time information. In one particular embodiment, the first field 350 is 32 bits and the second field 352 is 32-bits. The CAM 302 can further include an initial counter 354 to hold an initial counter value. As described below, the initial counter value is selected to achieve a desired aging time for CAM entries. In an exemplary embodiment, the CAM 302 can hold from four to sixty-four entries. It is understood that any number of bits and/or CAM entries can be used to meet the needs of a particular application.

An exemplary set of CAM operations includes:

CAM clear - invalidate all CAM entries.
CAM put <value> - fill an empty CAM entry with a given value.
If there is no empty slot in the CAM do nothing.
CAM lookup <value> - look up the CAM in search of the given value.
Output of the operation can either be a “hit” (value found) or “miss”
(value not found). In case of a CAM hit it is also given a time the entry
spent in the CAM and the entry is cleared.
CAM free <value> - look up the value in the CAM and in case
of a CAM hit clear the entry.

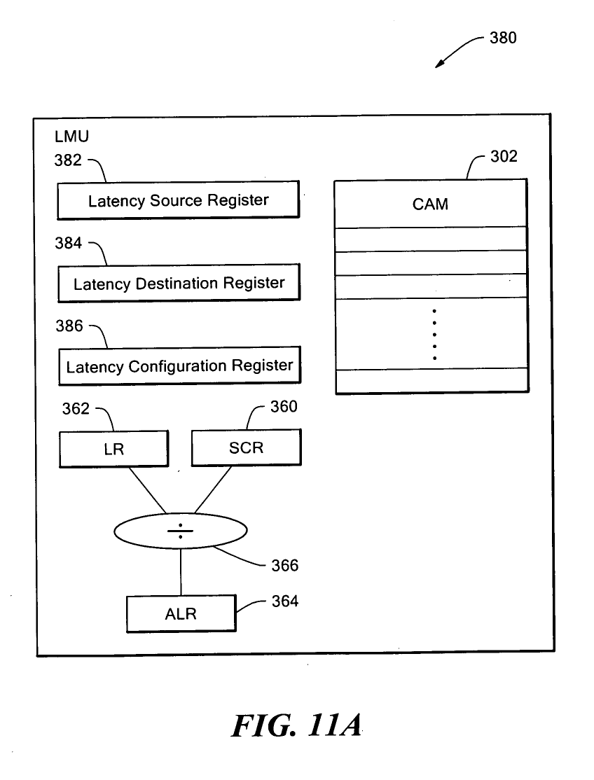

As shown in FIG. 11, the LMU can also include a samples counter register (SCR) 360, a latency register (LR) 362 and an average latency register (ALR) 364. A divide function 366 can receive inputs from the latency register 362 and the samples counter register 360 and provide an output to the average latency register 364.

It is understood that the term register should be construed broadly to include various circuits and software constructs that can be used to store information. The conventional register circuit described herein provides an exemplary embodiment of one suitable implementation.

In general, the LR 362 maintains a sum of the measured latencies of the data packets. The content of the ALR 366 is calculated by dividing the content of the LR 362 by the number of samples. To simplify the calculations the ALR 364 can be updated every 8, 16, 32 etc. updates of the LR 362. In an exemplary embodiment, a programmer has access to the ALR 364 and SCR 360.

In operation, when data is read from a source, such as a scratch ring or network interface, the CAM 302 (FIG. 10) is checked for an available entry. Upon identifying an available CAM entry, the packet identifier is stored in the first or packet ID field 350 of the entry and a value is stored in the second or counter field 352.

If the CAM is full, latency for the current packet is not measured. However, this should not be a problem because the latency measurement is statistical.

In an exemplary embodiment, the CAM entry counter field 352 is filled with an initial value stored in the initial counter 354. The value of the counter field 352 decreases with each clock cycle (or after a given number of cycles but this lowers the measurement accuracy). When the value in the counter field 352 reaches zero, the CAM entry is considered empty or aged. For example, if a value of 1,000,000,000 is stored in the initial counter 354 and the NPU speed is 1 GHz, then the aging period is one second. CAM entries that have aged are considered empty and available for use.

In case of a CAM hit, the value in the counter field 352 is subtracted from the value in the initial counter 354 and the result (a number of clock cycles) is added to the value in the latency register 362 (FIG. 11). The CAM entry is marked empty (counter is zeroed) and is made available for use.

Each CAM hit is counted in the samples counter register 360. Dividing the content of the latency register 362 by number of CAM hits in the samples counter register 360 calculates an average time (in clock cycles) of the processing period (an average time between reading a packet's identifier from the selected source and writing it to a selected destination).

In an exemplary embodiment, this calculation can be made every x number of samples (e.g., CAM hits) to simplify the computation and the result can be stored in the average latency register 364. The value in the average latency register 364 can be accessed via software instruction.

Because there is no guarantee that data read from the selected source will be written to the selected destination, the CAM entries can be aged. The maximum aging period can be configured by the user, set to a constant value, or automatically adjusted to the average latency.

It is believed that register overflows will not be an issue. It is expected that the first register to overflow will be the SCR 360 (FIG. 10). However, this allows for a measuring latency of over 4*10⁹ packets. Because of the limited capacity of the CAM, the latency of all processed packets will not be measured so it will take a significant amount of time to fill the 32-bits of the SCR register while several seconds of testing should be enough to get satisfactory results.

The number of CAM entries should be chosen after consideration of possible anomalies that can occur within a processing element. They may, for instance, cause the packet processing by even contexts to be faster then odd contexts. In one embodiment, the number of CAM entries as 1, 2, and 4 should be avoided. It is not necessary to measure the latency of each packet forwarded by the processor since results are statistical and it is acceptable to calculate the latency only for a factor of the processed network traffic.

In an exemplary embodiment, microcode instructions are provided to optimize data latency measurements as follows:

processing_start - adds entry to CAM in order to initialize the processing
time measurement. This instruction is used when the processing of the
packet received from a network interface is initiated.
processing_end - look up entry in CAM in order to finish the processing
time measurement. This instruction is used when the processing of the
packet received from the network interface is initiated.
processing_abort - clears entry in the CAM so the processing time
measurement is broken. This instruction may be used when a packet is
dropped and processing of the packet finishes unexpectedly.
ring_put - put data to a specified scratch ring. In addition to the standard
ring put, this instruction also performs the processing_start instruction
ring_get - read data from specified scratch ring. In addition to the
standard ring get, this instruction also performs processing_end
instruction

In one embodiment, the ring_put and ring_get instructions have the ring number as an argument to enable the latency measurement unit (LMU) to identify the ring with which the scratch ring operation is correlated. The LMU also knows the processing element number and the thread number.

FIG. 11A shows an exemplary LMU 380 having a latency source register 382, a latency destination register 384, and a latency configuration register 386. The LMU also contains a CAM 302 (FIG. 9), latency register 362, samples counter register 360, and average latency register 364 (FIG. 11). In an exemplary embodiment, each scratch ring, network interface, or other source/destination is assigned a unique number. The number of the selected source is placed in the latency source register 382 and the number of the selected destination is placed in the latency destination register 384. The latency configuration register 386 is for control information such as start/stop commands. For example, when a value of 0 is written to the latency configuration register 386 latency measurements are stopped. A programmer can then specify new source/destination information for new measurements if desired. A new aging value for the initial counter 354 (FIG. 10) can also be set. Latency measurements can begin when a value of 1, for example, is written to the latency configuration register 386. At this point the latency register 362, the samples counter register 360 and the average latency register 364 can be automatically cleared. Latencies can be summed at the end but the result would not include the time packets spend in the scratch rings.

It should be noted that it cannot be assumed that all of the data put into a particular scratch ring came from a specific processing element. When measuring the period between reading data from the source and writing it to the destination (e.g., a network interface or scratch ring) the packet identifiers that are the subject of input and output operations should be compared.

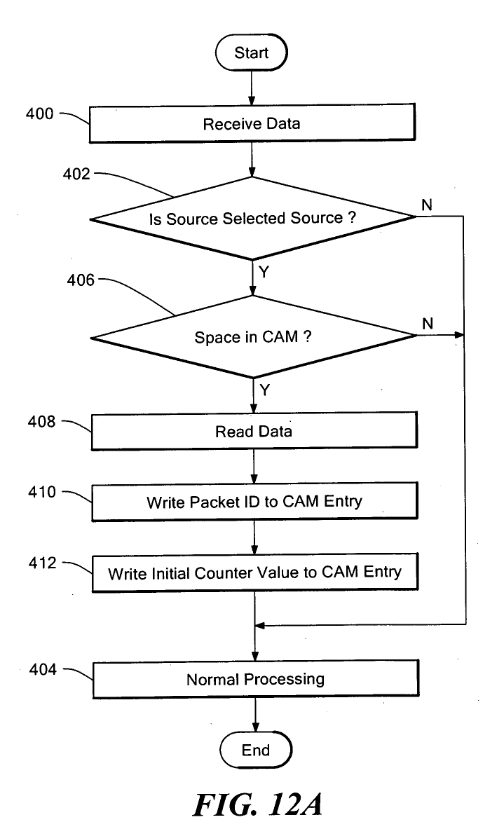

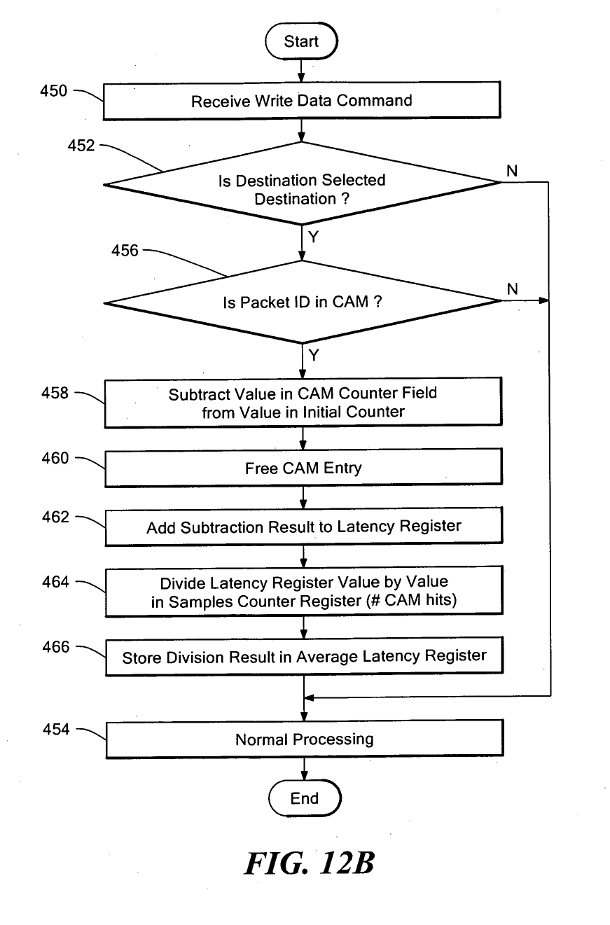

FIGS. 12A and 12B show an exemplary processing sequence to implement a latency measurement unit. FIG. 12A shows an illustrative read/get operation and FIG. 12B shows an illustrative write/out operation.

In processing block 400, data is received from a source, such as a network interface or scratch ring and in processing block 402 it is determined whether the data source is the source selected for latency measurement. If not, “normal” processing by the given processing element continues in block 404. If so, in decision block 406 it is determined whether there is space in the CAM. If so, then in processing block 408 the data is read. In processing block 410 the packet identifier value is written to the packet ID field of the CAM entry and in processing block 412 the initial counter value is written to the counter field. Processing continues in processing block 404.

As shown in FIG. 12B, in processing block 450 a processing element is to write data to a destination, e.g., network interface or scratch ring, and in decision block 452 it is determined whether the destination is the destination selected for latency measurements. If not, the processing element performs “normal” processing in processing block 454. If so, the CAM is examined to determine whether the packet identifier is present in decision block 456. If not (a CAM miss), processing continues in block 454. If the packet identifier was found (a CAM hit), in processing block 458, the value in the counter field of the CAM entry is subtracted from the value in the initial counter. In processing block 460, the CAM entry is freed for us. In processing block 462, the subtraction result is added to the value in the latency register. The value in the latency register is divided by the value in the samples counter register, which contains the number of CAM hits, to calculate an average time in clock cycles of the processing period in processing block 464. The division result in stored in the average latency register in processing block 466 and “normal” processing continues in block 454.

In an alternative embodiment, timestamp information can be stored for each CAM entry. In an exemplary embodiment, each processing element includes a 64-bit timestamp register. While 32 bits of the timestamp may be sufficient to measure latency, overflow should be controlled to avoid errors in calculations. The timestamp information can be used to measure latency in a manner similar to that described above.

While illustrative latency measurement unit configurations are shown and described in conjunction with specific examples of a multi-core, single-die network processor having multiple processing units and a device incorporating network processors, it is understood that the techniques may be implemented in a variety of architectures including network processors and network devices having designs other than those shown. Additionally, the techniques may be used in a wide variety of network devices (e.g., a router, switch, bridge, hub, traffic generator, and so forth). It is further understood that the term circuitry as used herein includes hardwired circuitry, digital circuitry, analog circuitry, programmable circuitry, and so forth. The programmable circuitry may operate on computer programs.

Other embodiments are within the scope of the following claims.

What is claimed is:

1. A processor unit, comprising:
a latency measurement unit, including
a content addressable memory (CAM) having a first field to store a packet identifier and a second field to store time information for a selected source and destination;
a first storage mechanism to store latency information from the CAM; and
a second storage mechanism to store CAM hit information.

2. The unit according to claim 1, wherein the processor unit has multiple cores and is formed on a single die.

3. The unit according to claim 1, further including a division mechanism to divide information from the first and second storage mechanisms to generate computed latency information.

4. The unit according to claim 3, further including a third storage mechanism to store the computed latency information.

5. The unit according to claim 4, wherein the computed latency information corresponds to average latency for a packet.

6. The unit according to claim 1, wherein the CAM further includes an initial counter to store a value corresponding to a desired aging time for CAM entries.

7. The unit according to claim 1, wherein the second field of the CAM is loaded with the value in the initial counter when a CAM entry is filled.

8. The unit according to claim 1, wherein latency is measured from a selected source to a selected destination.

9. A processing system, comprising:
a plurality of interconnected processing elements;
a memory to store information for transfer from a first one of the plurality of processing elements to a second one of the plurality of processing elements; and
a latency measurement unit coupled to the memory, the latency measurement unit including a content addressable memory (CAM) having a packet identifier field and a time field to measure data latency from a selected source to a selected destination.

10. The system according to claim 9, wherein the selected source is selected from the group consisting of an interface and a memory.

11. The system according to claim 10, wherein the interface comprises a network interface and the memory comprises scratch memory.

12. The system according to claim 9, wherein the CAM includes an initial counter to hold a value corresponding to a desired aging duration.

13. The system according to claim 9, wherein the latency measurement unit includes a latency register to hold a sum of latency information, a samples counter register to hold a count of CAM hits, and an average latency register to store latency information derived from the latency register and the samples counter register.

14. The system according to claim 13, wherein the latency measurement unit includes a division mechanism to divide information in the latency register and the samples counter register and provide a result to the average latency register.

15. A method of measuring data latency, comprising:
selecting a source and destination to measure latency;
identifying packets associated with the source and destination;
writing packets identified with the source to a content addressable memory (CAM) having a packet ID field and a time field;
extracting CAM entries identified with the destination; and
computing latency measurements from the extracted CAM information.

16. The method according to claim 15, wherein the source is selected from the group consisting of an interface and a memory.

17. The method according to claim 15, further including inserting an aging value in an initial counter, wherein the aging value corresponds to an aging duration.

18. The method according to claim 17, further including placing the aging value in the time field of a CAM entry.

19. The method according to claim 15, further including placing information corresponding to the value in the time field of the CAM into a latency register, maintaining a count of CAM hits in a samples counter register, and placing computed latency information into an average latency register.

20. The method according to claim 19, further including dividing information from the latency register and the samples counter register.

21. A network forwarding device, comprising:
at least one line card to forward data to ports of a switching fabric, the at least one line card including a network processor having a plurality of processing elements and a latency measurement unit (LMU), the latency measure unit including
a content addressable memory (CAM) having a first field to store a packet identifier and a second field to store time information;
a first register to store latency information from the CAM;
a second register to store CAM hit information; and
a third register to store computed latency information;

22. The device according to claim 21, wherein the LMU further includes a division mechanism to compute the latency information from values in the first and second registers.

23. The device according to claim 21, wherein the CAM further includes an initial counter to store a value corresponding to a desired aging time for CAM entries.
